(19) United States
(12) Patent Application Publication
(10) Pub. No.: US 2008/0168065 A1
(43) Pub. Date: Jul. 10, 2008

(54) System and Method for Universal Web-History Service in Single or Collaborative Environments

(75) Inventors: Dimitri Kanevsky, Ossining, NY (US); Steven J. Mastrianni, Unionville, CT (US); Clifford A. Pickover, Yorktown Heights, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,069

(22) Filed: Jan. 5, 2007

(51) Int. Cl. G06F 17/30

(52) U.S. Cl. 707/10; 707/E17.121

(57) ABSTRACT

In an embodiment of the present invention a web collaboration tool is utilized for collecting references to the web pages visited by a user and displaying a visual indication of the visited pages in the browser when another user or group member views a previously visited page. The present invention also relates to a web collaboration server aiding the tool in receiving the identifiers of visited pages, storing the identifiers in a database and reporting the identifier to other users when they visit a web page already visited. Additionally, the present invention also relates to a method of visually differentiating links in a Word document using some special symbol to indicate visited links when printing in black and white.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a web collaboration tool which is utilized for collecting references to the web pages visited by a user and displaying a visual indication of the visited pages in the browser when another user or group member views a previously visited page. In particular, a web collaboration server aiding the tool in receiving the identifiers of visited pages, storing the identifiers in a database and reporting the identifier to other users when they visit a web page already visited.

2. Description of Background

Before our invention as a user conducts research on the Internet, they may use a standard web browser feature that changes the link color of links as various websites are visited. In this regard, the color change feature enables a user to determine visually that a particular web location has previously been viewed and or visited.

A disadvantage of this method is that the link color indication of past-sites visited only operates for the particular computer a user is using—and as such this indication does not persist when the user changes computers. As example, after browsing a website on a computer at work the web link color changes indicating that the site has been previously visited. When a computer at home is used to perform a similar web search there is no clear indication of these prior websites visited. As a result, web links previously visited are not as easy to remember since the link color does not indicate the website has been previously visited.

This disadvantage is compounded further when members of a group try to collaborative on Internet based research. In this regard, group members can be unable to ascertain which web pages have been viewed and or which research has already been completed. This in part gives rise to the present invention.

### SUMMARY OF THE INVENTION

The shortcomings of the prior art are overcome and additional advantages are provided through the provision of a method for universal web-history service in single or collaborative environments, the method comprising: receiving a request for a web page at a server from a user by way of a client data processing device, the user is associated with a group of users; retrieving a plurality of information from the server, the plurality of information is related to the group of users; obtaining the web page from a global network based data processing resource; building a modified web page based in part on the plurality of information, such that any member of the group of users receives the same modified web page; and responding to the request by sending the modified web page to the client data processing device.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which permits more effective use of web-browser and related information-presentation systems in both a single-user and collaborative setting.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a global network based data processing system;

FIG. 2 illustrates one example of a method of using a client data processing device to selectively route web page requests to a proxy server; and

FIG. 3 illustrates one example of a method of obtaining from a global network data processing resource a web page and reformatting the web page prior to serving the webpage to a requesting client data processing device.

The detailed description explains the preferred embodiments of the invention, together with advantages and features, by way of example with reference to the drawings.

### DETAILED DESCRIPTION OF THE INVENTION

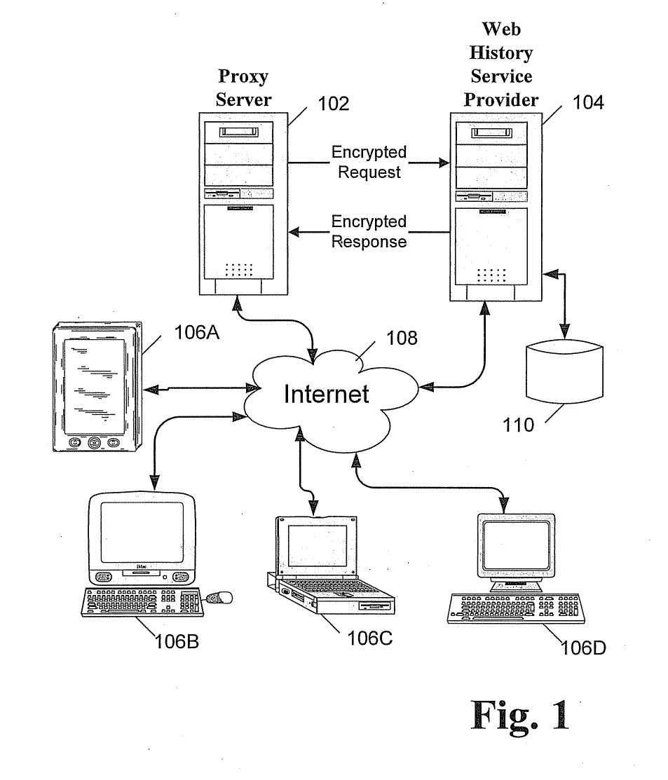

Turning now to the drawings in greater detail, referring to FIG. 1 there is illustrated one example of a global network based data processing system. In an exemplary embodiment, when the web history feature is enabled a plurality of data processing devices 106 communicate across a global network Internet 108 to a proxy server 102. When the web history feature is not enabled then the data processing devices 106 communicate over the global network (internet 108) directly with other global network based data processing resources. The proxy server 102 data communicates with a server 104 having a database 110 in a secured encrypted manner where user, group and other data are combined with web page requests, and database stored histories to obtain and reformat as necessary web pages. Such reformatting of the web pages allows the web links contained on the web page to be modified based in part on the server stored information, user, group, and or other information.

In this regard, the system of FIG. 1 enables a plurality of exemplary embodiments of methods of saving web histories, associating web histories with users and groups of users and modifying web pages to better indicate which web links have been previously visited. In addition, such web pages can be reformatted to use other visual indicators besides color change (such as characters like ‘v’ next to the web link) to indicate a web link has been previously clicked such that for example on a block an white printer where color change links may not be easily discernable the characters such as ‘v’ will appear on the links that have previously been view and or accessed. Data processing devices 106 include personal data assistant 106A, personal computer (PC) 106B and 106D, and a laptop computer 106C.

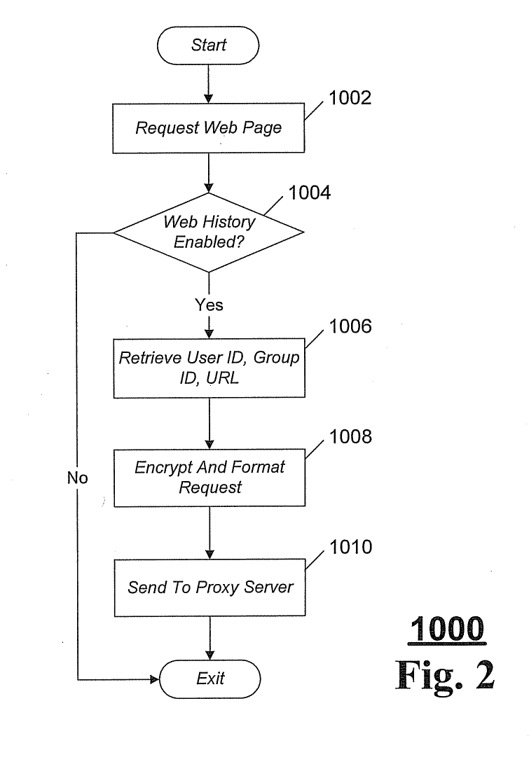

Referring to FIG. 2 there is illustrated one example of a method using a client data processing device 106 to selectively route web page requests to a proxy server. In an exemplary embodiment of the present invention, a method to allow the link color change (i.e., Web history of visited web sites) to persist across computers and accessible to a group by having an online service keep track of the links and colorize them accordingly on all computers and or users in the group. Furthermore, such an online service can be configured to encrypt data traffic to better insure the security of data and the privacy of the users.

In an exemplary embodiment, for example and not limitation, a user logs onto a server, exchanges certificates, keys, and or other electronic credentials. The user's preferences are merged/replicated locally, and then saved on the server. This is not information that resides on or is maintained on any server a user visits, just the server of a user's provider. When the user visits any web site, the proxy routes the user through the provider proxy site. The method 1000 begins in block 1002.

In block 1002 a user makes a web page request via a web browser or other client side suitable software. Processing then moves to decision block 1004.

In decision block 1004 a determination is made as to whether or not a web history feature is enabled. If the resultant is in the affirmative that is the web history feature on the client side data processing device 106 is enabled then processing moves to block 1006. If the resultant is in the negative that is the web feature on the client side data processing device 106 is not enabled then the routine is exited and the web browser is returned a web page that is not reformatted with respect to the web links indicators (color change or other visual indicators). Processing then moves to block 1006.

In block 1006 the proxy server 102 obtains the user's ID, group ID, uniform resource locator (URL) and or other data and or information from the server 104. Processing then moves to block 1008.

In block 1008 the user's web page request is encrypted and formatted as necessary. Processing then moves to block 1010.

In block 1010 the encrypted and formatted request is sent to the proxy server. The routine is then exited.

In another exemplary embodiment, visual indicia for links for collaborative or group environment provide a visual indication of link status/history for a group of users. For example, a user not only has the ability to have the history of his own searches on various computers made available (and thus the visited text links are highlighted and or marked appropriately), but an embodiment of the present invention supplies the option of incorporating groups of users individual histories and highlighting the collective sum of all the users (group) histories. This exemplary embodiment method is accomplished in a secured manner protecting data, user, and group privacy. In addition, this exemplary embodiment is very useful for research, collaborative works, and for other purposes.

As an example and not a limitation, a member of the group and his team are performing research. It is useful for the member of the group to see that a second member of the group has visited certain sites in the past (and thus this second member is likely to be aware of the content). Now that the member has this extra information, the member can focus on websites that no one in his team has visited. In general in this exemplary embodiment of the present invention, when a team is doing research for a scientific or business paper, a team member will know if a group member has already looked at a site (e.g. by observing the link color in a browser), and thus a team member can selectively focus on links that the group has not looked at yet.

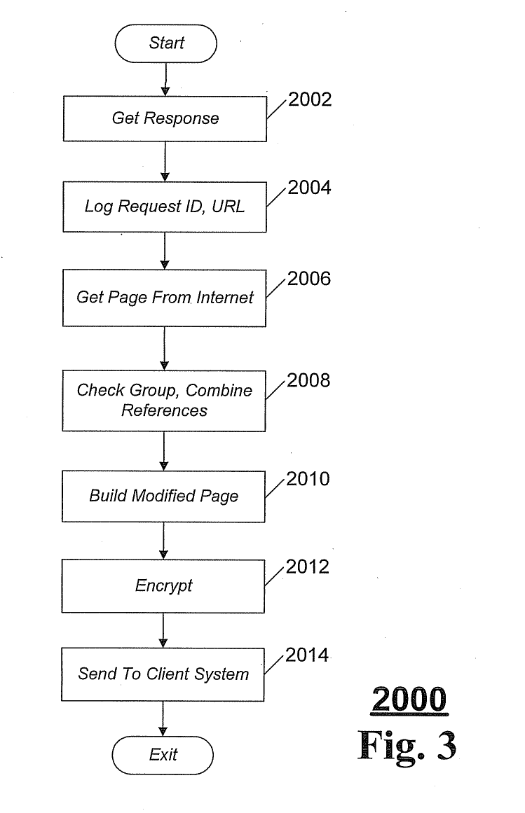

Referring to FIG. 3 there is illustrated one example of a method of obtaining from a global network data processing resource a web page and reformatting the web page prior to serving the webpage to a requesting client data processing device 106. In an exemplary embodiment a requesting client device generates a request for a web page. The proxy server 102 obtains the web page and reformats the web page as necessary to indicate the history of the user and or group influences on the web links. In this regard, the color and or additional character indication can be changed and or added to web links based on the previously viewed and or visited history of the individual user and or group. The method begins in block 2002.

In block 2002 a response is received from a server 104. Processing then moves to block 2004.

In block 2004 the request ID and URL is logged. Processing then moves to block 2006.

In block 2006 the web page requested is obtained from the global network based data processing resource via Internet 108. Processing then moves to block 2008.

In block 2008 a check of the groups is performed and references are combined. Processing then moves to block 2010.

In block 2010 a modified web page is built. In the traditional way a web browser is use, previously visited sites are kept in the browser history, which can be cached for a period of time. When the browser encounters a link, it checks the history to see if that URL had been previously visited. If so, it colors the link based on a set of colors defined in the browser settings. The persistence is managed by this cached URL list.

In contrast, in an exemplary embodiment of the present invention the persistence is not determined by the browser, but managed by the service and proxy. The URL encountered by the browser is persisted or colored by the service and/or proxy of the present invention, not by the local browser cache. While the browser is free to continue keeping track of its own history list, the service and proxy of the present invention can override the local browser cache and color scheme based on a collaborative URL list on the server. The viewed web page is intercepted by the proxy, and based on the collaborative data; the web page is parsed, modified, built and sent to the browser without the browser being aware of the proxy. As far as the browser is concerned, it's just rendering a web page. It has no knowledge that the page had been modified and rebuilt. The state is maintained by the present invention, thus the history maintained by the present invention is maintained no matter where the user is connected and without regard to a specific computer system, operating system, browser type, or local history. Processing then moves to block 2012.

In block 2012 the data communication is encrypted. Processing then moves to block 2014.

In block 2014 the data communication is sent to the requesting client device. The routine is then exited.

In another exemplary embodiment, another feature of the present invention makes use of visual indicia of link color on monochrome printer. In this regard, the present invention modifies web pages such that printed versions of web pages on common black and white printers provide a visual indication of the link visit status—something that is currently difficult to glean without the use of color. The information may also be indicated in Microsoft Word when links are referenced. For example, when a user copies links to MICROSOFT WORD, MICROSOFT WORD does not copy link colors. Thus, if a user has a list of links in a MICROSOFT WORD document, then the user has no idea what has already been browsed.

Even if color changes where utilized in the MICROSOFT WORD document for web links, when printing this document on a monochrome printer, this information disappears. As such a method by which the printing process adds a visible marks (other than color change) to the printed black and white page to indicate what color the document text was prior to printing.

The concept of having the printing process automatically mark colors when it prints in black and white has novel aspects. In an exemplary embodiment, for example and not limitation, when text associated with a visited link is printed on a monochrome printer, a superscript ‘v’ is posted next to the visited link. Other symbols can be used to provide more information, such as tie number of times a site was visited, the importance of the site, and or other required and or desired information.

In a plurality of exemplary embodiments of the present invention a method for universal ‘collaborative link’ management is taught. In addition, in a plurality of exemplary embodiments, web links may be annotated in such a way as to provide this additional group information. Web links could point to metadata (e.g. who looked at a web page, date browsed, and any notes that a team member may associate with the links). In general, this is a means for annotating links, among other things, in a collaborative environment.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for universal web-history service in single or collaborative environments, said method comprising:
receiving a request for a web page at a server from a user by way of a client data processing device, said user is associated with a group of users;
retrieving a plurality of information from said server, said plurality of information is related to said group of users;
obtaining said web page from a global network based data processing resource;
building a modified web page based in part on said plurality of information, such that any member of said group of users receives the same said modified web page; and
responding to said request by sending said modified web page to said client data processing device.

2. The method in accordance with claim 1, further comprising:
retrieving a second plurality of information, said second plurality of information is a plurality of metadata, or a URL.

3. The method in accordance with claim 2, wherein said plurality of metadata includes data related to who has accessed certain web pages.

4. The method in accordance with claim 3, wherein said plurality of metadata includes data related to the date certain web pages were accessed.

5. The method in accordance with claim 4, wherein said plurality of metadata includes data related to a second plurality of information supplied by members of said group of users.

6. The method in accordance with claim 5, wherein said server is a proxy server.

7. The method in accordance with claim 6, further comprising:
encrypting said request.

8. The method in accordance with claim 7, further comprising:
communicating said request to a second server.

9. The method in accordance with claim 8, further comprising:
encrypting said response.

10. The method in accordance with claim 9, further comprising:
communicating said response from said second server to said server.

11. The method in accordance with claim 10, further comprising:
storing selectively said request and or said metadata.

12. The method in accordance with claim 11, wherein when printing said modified web page on a black and white printer said modified web page has additional characters added to web links that have previously been viewed.

13. A web collaboration tool comprising:
a collector operable to receive a reference to a web page from a web browser and send said reference to a network-attached database, said web page having been visited by a first user; and
an indicator operable to display a visual indication within said web browser upon viewing a previously visited web page, said visual indication identifying a second user to said first user, said second user having visited said previously visited page.

14. The method in accordance with claim 13, wherein said reference includes a plurality of metadata, said plurality of metadata is not web history data.

15. A web collaboration server comprising:
a receiver operable to receive a first identifier from a web browser and a reference to a web page, said web page having been visited by a first user;
a database for storing said first identifier in association with said reference to said web page; and
a reporter operable to send a second identifier to said web browser when said database contains said second identifier in association with a reference to said web page.

16. The method in accordance with claim 15, wherein said reference includes a plurality of metadata, said plurality of metadata is not web history data.
